(19) United States
(12) Patent Application Publication
(10) Pub. No.: US 2014/0168975 A1
(43) Pub. Date: Jun. 19, 2014

(54) LIGHTING FIXTURE WITH FLEXIBLE LENS SHEET

(71) Applicant: AVAGO TECHNOLOGIES GENERAL IP (SINGAPORE) PTE. LTD., Singapore (SG)

(72) Inventors: Keat Chuan Ng, Penang (MY); Ju Chin Poh, Penang (MY); Kheng Leng Tan, Penang (MY)

(73) Assignee: Avago Technologies General IP (Singapore) Pte. Ltd, Singapore (SG)

(21) Appl. No.: 13/715,798

(22) Filed: Dec. 14, 2012

(51) Int. Cl. F21V 5/00

(52) U.S. Cl. CPC F21V 5/007
USPC 362/244; 362/331

(57) ABSTRACT

A lighting system and lighting fixture cover are disclosed. Specifically, the lighting system can provide an optimum light beam shape for a number of different lighting applications. The lighting system includes a PCB and cover with one or more lenses and one or more snap-fit locking mechanisms to secure the cover to the PCB. The cover enables a narrow beam output without sacrificing beam intensity or brightness. The cover simplifies the assembly process of a lighting fixture.

### FIELD OF THE DISCLOSURE

The present disclosure is generally directed toward housings and covers for light sources.

### BACKGROUND

Light Emitting Diodes (LEDs) have many advantages over conventional light sources, such as incandescent, halogen and fluorescent lamps. These advantages include longer operating life, lower power consumption, and smaller size. Consequently, conventional light sources are increasingly being replaced with LEDs in traditional lighting applications. As an example, LEDs are currently being used in flashlights, camera flashes, traffic signal lights, automotive taillights and display devices. LEDs are also becoming more prevalent in residential, commercial, and industrial lighting applications.

Existing LED-based canopy lighting uses individual reflector cups with wide viewing angles: −30 degrees, 90 degrees, or an oval shape of 45×75 degrees. Current canopy light reflectors are not able to achieve an oval shape with a viewing angle of less than 40 degrees. Further, existing LED-based canopy lighting that use reflector cups places an individual reflector on each of the individual Printed Circuit Boards (PCBs). The reflector cups are attached using mechanical locking and screws. Additionally, the front of the canopy lighting assembly is covered by tempered glass. The process to make the existing LED-based canopy lighting assemblies is time consuming because of the significant amount of mechanical locking Plus, the tempered glass easily breaks if the screws used in the mechanical locking are screwed in too tightly. Such breakage increases production time, cost, and safety risks.

### SUMMARY

It is, therefore, one aspect of the present disclosure to lighting solutions with a relatively narrow viewing angle. Specifically, embodiments of the present disclosure provide the ability to produce canopy lighting and other types of lighting with a viewing angle that is less than or equal to 40 degrees. The canopy lighting solutions discussed in the present disclosure provide flexibility regarding the desired lens angle and shape. Narrow viewing angles in canopy lighting are useful in warehouse walkways between racks, for instance, because the narrow angle light is not blocked by the racks and, thus, can provide sufficient lighting.

It is also an aspect of the present disclosure to simplify the assembly process and reduce the assembly time and cost associated with making canopy lighting and other lighting fixtures. More specifically, embodiments of the present disclosure solve some problems associated with tempered glass covers breaking during assembly. Reducing the tempered glass breakage problem, in turn, reduces the assembly cost, time, and safety risks associated with manufacturing LED-based canopy lighting. Further, the present disclosure reduces the total weight of the lighting fixture.

The lighting fixture cover, as disclosed herein, can be made of an elastic, flexible material (such as silicon) to reduce its weight and tendency to break. The cover may include a U-shaped lock-fit edge for snapping the cover onto the a Printed Circuit Board (PCB) or lighting fixture. This would eliminate the need to mechanically lock the tempered glass cover onto the lighting fixture using screws and, therefore, would simplify the assembly process. Additionally, the cover may have lenses formed into it, thus eliminating the need to mechanically lock an individual reflector, reflector cup, or lens on each PCB or light source and further simplify the assembly process. Because the cover has the lenses formed within itself, the cover may be weather resistant whereby the lighting fixture may be used outdoors.

One aspect of the present disclosure is to provide tube lighting and decorative lighting solutions with similar advantages to the canopy lighting embodiments described herein. More specifically, it is contemplated that the features described herein with respect to canopy lighting, for example, can be applied to many other types of lighting including tube lighting, pendant lighting, recessed lighting, etc.

The present disclosure will be further understood from the drawings and the following detailed description. Although this description sets forth specific details, it is understood that certain embodiments of the invention may be practiced without these specific details.

### BRIEF DESCRIPTION OF THE DRAWINGS

The present disclosure is described in conjunction with the appended figures:

FIG. 1 is an isometric view of a first lighting canopy in accordance with embodiments of the present disclosure;

FIG. 2 is an isometric view of a second lighting canopy in accordance with embodiments of the present disclosure;

FIG. 3 is an isometric view of a first lighting fixture in accordance with embodiments of the present disclosure;

FIG. 4 is an isometric view of a lighting fixture cover with lenses in accordance with embodiments of the present disclosure;

FIG. 5 is an A-A view of the lighting fixture cover in FIG. 4;

FIG. 6 is a side view of a second lighting fixture in accordance with embodiments of the present disclosure;

FIG. 7 is a side view of a third lighting fixture with the cover detached in accordance with embodiments of the present disclosure;

FIG. 8 is a side view of a fourth lighting fixture in accordance with embodiments of the present disclosure; and

FIG. 9 is a flow diagram depicting a manufacturing method in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. Preferred embodiments are described to illustrate the present invention, not to limit its scope, which is defined by the claims. Like elements in various embodiments are commonly referred to with like reference numerals. It being understood that various changes may be made in the function and arrangement of elements without departing from the spirit and scope of the appended claims.

Although certain components will be described as being constructed with certain materials, those skilled in the arts will appreciate that any type of suitable material used for one component may be used for other components. For example, any one of the components described herein may be constructed of metal, steel, alloys, plastic (e.g., PET, PTFE, PVC, etc.), ceramic, glass, wood, rubber, polymers, silicone, or combinations thereof.

It will be understood by one of ordinary skill in the art that the embodiments presented herein are not limited to just canopy lighting. Concepts may be applied to tube lighting, pendant lighting, recessed lighting, etc.

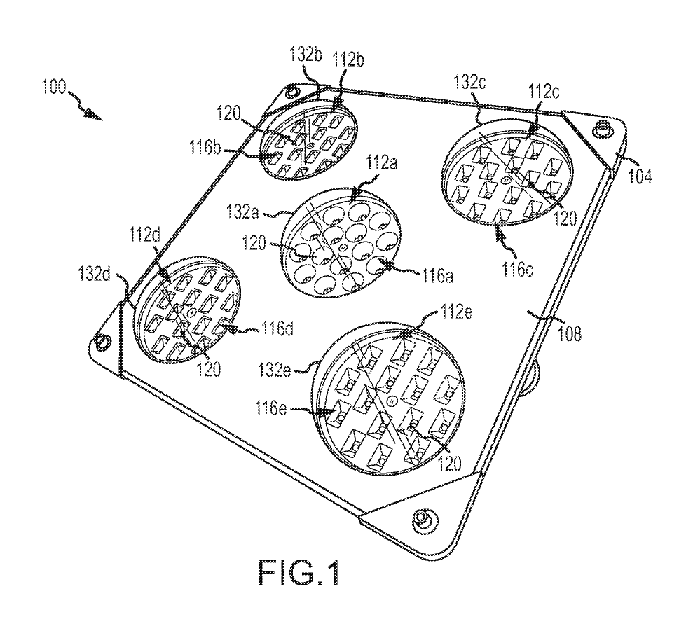

With reference initially to FIG. 1, a first lighting canopy 100 will be described in accordance with embodiments of the present disclosure. The first lighting canopy 100 may also be referred to herein as a luminescence. The first lighting canopy 100 may include one or more components that enable the first lighting canopy 100 to provide light in a number of different lighting applications (e.g., residential, industrial, commercial, etc.). Furthermore, various components of the first lighting canopy 100 may be interchangeable with other similar types of components that will be described in further detail hereinafter. In particular, the components of the first lighting canopy 100 may be modular in nature and are, therefore, easily adaptable to a number of different lighting applications. In some embodiments, the first lighting canopy 100 may be considered a hybrid lighting canopy because it is capable of providing light sources of multiple types (e.g., light sources having different lighting properties such as brightness, intensity, color, shape, size, etc.).

Non-limiting example components that may be included in the first lighting canopy 100 include a support structure 104, a cover 108 with a plurality of lenses 132a-N, and a plurality of lighting clusters 116a-N (where N is greater than or equal to one). In the embodiment depicted in FIG. 1, the first lighting canopy 100 comprises five lighting clusters 116a-e. The lighting clusters 116a-e may each be positioned on the support structure 104 so that the lighting clusters 116a-e are evenly distributed across the major surface of the first lighting canopy 100.

In some embodiments, the cover 108 is provided with a plurality of lenses 132a-N that fit over a plurality of recesses or holes 112a-N (where N is greater than or equal to one). In the embodiment depicted in FIG. 1, the cover 108 comprises five lenses 132a-e, which fit over or cover the five recesses 112a-e, respectively. Each recess 112a-e is configured to receive or fit over a different lighting cluster 116a-e, respectively. The cover 108 may be made out of any type of material such as polymers, silicone, glass, ceramics, etc. In an embodiment, the cover 108 may be made of a flexible material such as silicone. The cover 108 with lenses 132a-e is used to control light beams and the angle at which they are emitted from the canopy 100. More specifically, the lenses 132a-e may shape light at narrow viewing angles, e.g., less than 40 degrees even though the light emitted by the light sources (e.g., LEDs) within a cluster 116 is emitted at an angle greater than the narrow viewing angle. Further, the lenses 132a-e may achieve an oval shape with a viewing angle of less than 40 degrees. In some embodiments, the lenses 132 on the cover 108 allow the lighting clusters 116 to provide different light beam shapes, thereby increasing the ways in which light is distributed by the first lighting canopy 100. The cover 108 may also be used to improve the aesthetic nature of the first lighting canopy 100 as well as cover and protect various electronic components of the first lighting canopy 100 that provide electrical current to the light sources contained within the lighting clusters 116a-e.

Alternatively or additionally, in some embodiments the lenses 132a-e are formed within the cover 108 such that the cover 108 is weather resistant and/or waterproof to enable the first lighting canopy 100 to be used outdoors. The cover may be rated using the IP Code (i.e., Ingress Protection Rating or International Protection Rating). Further, in some embodiments, the cover 108 is made of a polymer, such as silicone, so that the cover 108 will also be heat resistant and allow the first lighting canopy 100 to be used outdoors.

In some embodiments, the cover 108 may fit over the entire first lighting canopy 100 such that each lens 132 covers one lighting cluster 116. Alternatively or additionally, the cover 108 may fit over the entire first lighting canopy 100 and may have one lens 132 to cover each light source or reflector cup 120. Further, the cover 108 may include a combination of both, where the cover 108 has some lenses 132 that cover an entire lighting cluster 116 and other lenses 132 that cover each individual light source or reflector cup 120.

In some embodiments, each lighting cluster 116a-N may have its own cover 108a-N, respectively. Therefore, the first lighting canopy 100 may have a plurality of covers 108a-N (where N is greater than or equal to one).

PCBs are typically used with LEDs. Therefore, in some embodiments, the first lighting canopy 100 may have one PCB on which each lighting cluster 116 is attached. Additionally, in some embodiments, each lighting cluster 116a-N may be attached to its own PCB such that the lighting canopy has N PCBs (where N is greater than or equal to one).

As can be seen in FIG. 1, one or more of the lighting clusters may have one or more different light-distributing properties from other lighting clusters. In the example depicted in FIG. 1, the first lighting cluster 116a comprises a plurality of reflector cups 120 that are different in shape than the reflector cups 120 in the other lighting clusters 116b-e. More specifically, the reflector cups 120 of the first lighting cluster 116a are configured with a circular shape whereas the reflector cups 120 of the other lighting clusters 116b-e are configured with a rectangular shape. In some embodiments, the varied nature of the reflector cups enables the hybrid first lighting canopy 100 to provide a more evenly distributed amount of light without sacrificing beam intensity. Furthermore, the reflector cups 120 of the lighting clusters 116 may have holes or recesses at their bottom surface that fit around the light source and mate with the top surface of the PCB.

Although the first lighting cluster 116a is depicted as having reflector cups of a first type that are different from the reflector cups of the other lighting clusters 116b-e, it should be appreciated that the lighting clusters may have other properties that are different to allow the lighting clusters to provide different beam shapes, thereby increasing the ways in which light is distributed by the first lighting canopy 100. As some non-limiting examples, one of the lighting clusters 116 may have a plurality of reflector cups 120 of a first type (e.g., narrow angle reflector cups designed to emit light beams between 30 degrees and 60 degrees, wide angle reflector cups designed to emit light beams between 90 degrees and 120 degrees, oval shaped reflector cups, rectangular shaped reflector cups, square shaped reflector cups, multi-shaped reflector cups, no reflector cups) while another of the lighting clusters 116 may have a plurality of reflector cups 120 of a second type (e.g., any of the above-described types of reflector cups but different from the first type).

In some embodiments, the lighting clusters 116 may not have reflector cups 120 at all because the lenses 132 within the cover 108 may provide the necessary light-shaping properties. Although the lenses 132 depicted in FIG. 1 all look the same, it should be appreciated that the lenses 132 on the cover 108 may vary in accordance with embodiments of the present disclosure. For instance, one of the lighting clusters 116 may have beam-shaping lenses of a first type, whereas another of the lighting clusters 116 may have beam-shaping lenses of a second type. Alternatively or additionally, the cover 108 may have beam-shaping lenses 132 of a first type over one lighting cluster 116 and a beam-shaping lens 132 of a second type over a second lighting cluster 116. The first lens type may vary from the second type based on one or more of shape (e.g., domed, flat, multi-focal, etc.), material (e.g., epoxy, silicone, a hybrid of silicone and epoxy, phosphor, a hybrid of phosphor and silicone, an amorphous polyamide resin or fluorocarbon, glass, plastic, combinations thereof), diffracting elements, tint/color, height, width, etc.

Another light-shaping aspect that may vary from lighting cluster 116 to lighting cluster 116 is the number of light sources and reflector cups 120 provided in different types of lighting clusters 116. For instance, one type of lighting cluster may have a first number of light sources and reflector cups 120, whereas a second type of lighting cluster may have a second number of light sources and reflector cups.

Further still, while the first lighting canopy 100 is depicted as having two different types of lighting clusters, it should be appreciated that the number of different lighting clusters may vary from anywhere between 2 and N. In other words, the first lighting canopy 100 (and any other lighting canopy described herein) may comprise two different types of lighting clusters up to N different types of lighting clusters. Using the example of FIG. 1, there may be 2, 3, 4, or 5 different types of lighting clusters without departing from the scope of the present disclosure.

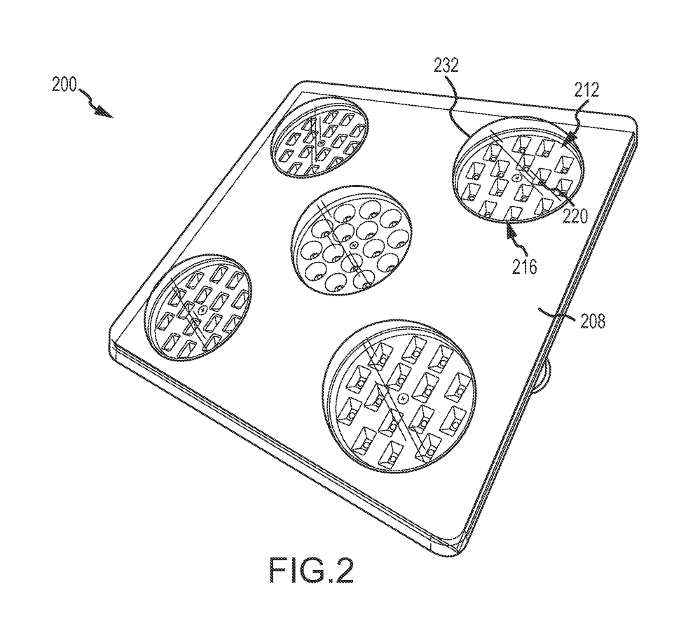

With reference now to FIG. 2, a second lighting canopy 200 will be described in accordance with at least some embodiments of the present disclosure. The second lighting canopy 200 may be similar or identical to the first lighting canopy 100 in that both canopies have a plurality of lighting clusters as well as light sources in the lighting clusters. In fact, the second lighting canopy 200 may be the first lighting canopy 100 but with a different cover 208 that has a different number of lenses 232 over a different number of recesses 212 or a different attachment mechanism, i.e., no support means 104 as shown in FIG. 1.

In some embodiments, the second lighting canopy 200 comprises a cover 208 with a U-shaped lock-fit edge to secure the cover 208 to the second lighting canopy 200. Each recess 212 is configured to receive or fit around a different lighting cluster 216. As with the first lighting canopy 100, the second lighting canopy 200 may have lighting clusters 216 of different types. Although the lighting clusters depicted in FIG. 2 vary based on reflector cup type, it should be appreciated that the way in which lighting clusters vary can be based on one or more of reflector cup properties, lens properties, material properties, number of light sources (e.g., LEDs), and combinations thereof.

In the embodiment shown in FIG. 2, the lighting cover 208 includes a U-shaped lock-fit edge that snaps around the PCB to keep the cover 208 on the second lighting canopy 200. The U-shaped edge may surround the entire perimeter of cover 208 such that the U-shaped edge is on all four sides of the cover 208 and snaps onto the PCB on all four sides. Having the U-shaped edge would further protect the light clusters 216 and other electrical components of the second lighting canopy 200 from moisture, heat, and weather. In one embodiment, there are many advantages of using a cover 208 with a U-shaped edge, which are further explained below in connection with FIGS. 5-8.

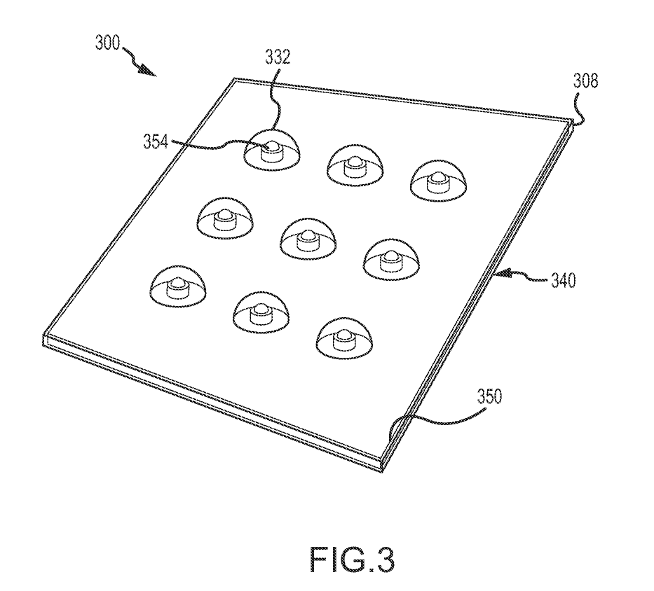

With reference now to FIG. 3, a first lighting fixture 300 will have its component parts described in further detail. It should be appreciated that the details described herein about the component parts of the first lighting fixture 300 may apply to component parts of the first or second lighting canopy 100, 200. Moreover, any aspect described in connection with the first or second lighting canopies 100, 200 may apply to the first lighting fixture 300.

FIG. 3 shows in particular how the cover 308 with lenses 332 may have one lens over each light source 354. In some embodiments, the components that may be included in the first lighting fixture 300 are, without limitation, a cover 308 with lenses 332, a PCB 350, and a plurality of light sources 354. In some embodiments, the light sources 354 may be single die LEDs or other LEDs and may vary with respect to one or more of brightness, intensity, shape, size, and color.

In some embodiments, the first lighting fixture 300 also comprises wires and/or circuitry that carries current from the power supply to the PCB 350. More specifically, the power supply may comprise an AC-to-DC power converter and various other power-conditioning circuits that enable the power supply to connect to an external AC power source, but provide DC power to the light sources 354 (e.g., LEDs) mounted on the PCB 350. Alternatively, the power supply may comprise a DC power source that provides DC power to the light sources 354 on the PCB 350.

As discussed in connection with FIGS. 1 and 2, a cover may include a plurality of lenses 332 that cover the plurality of light sources 354. Further, the cover 308 with lenses 332 may be used to emit light beams at a desired angle. More specifically, the lenses 332 may emit light at narrow viewing angles, e.g., less than 40 degrees. Further, the lenses 332 may achieve an oval shape with a viewing angle of less than 40 degrees. As can be seen in FIG. 3, the light sources 354 may be mounted on the PCB 350. Any type of known LED may be mounted to the PCB 350 including, without limitation, Surface Mount Technology (SMT) LED, through mount LEDs, or combinations thereof. The pattern in which the light sources 354 are mounted on the PCB 350 may correspond to the same pattern of the lenses 332 on the cover 308. The light sources 354 may be interchangeable and modular, which means that a light source 354 of one type may be replaced with a light source 354 of another type by simply removing the cover 308, removing the light source 354, then mounting a different light source 354 to the PCB 350.

In some embodiments, the light sources 354, which are modular, may also have reflector cups or may be in clusters, as shown in FIGS. 1 and 2. In some embodiments, this may require the clusters to also be modular or movable on the PCB 350. Alternatively or additionally, a light source 354 or a reflector cup cluster may only replace another light source 354 or reflector cup cluster if it has the same number or greater number of light sources 354 or reflector cups. If the replacement reflector cup cluster comprises a greater number of reflector cups, then either the additional reflector cups may be empty (e.g., without a light source) or additional light sources 354 may be mounted to the PCB 350 where the reflector cups will be positioned. However, the replacement light source 354 or reflector cup cluster must be approximately the same size such that the replacement light source 354 or reflector cup cluster fits underneath the lens 332.

In some embodiments, the PCB 350 is a conventional PCB 350 that comprises composites that are manufactured in accordance with the FR-4 and/or G-10 specification. It should be appreciated, however, that the PCB 350 may be rigid or flexible without departing from the scope of the present disclosure.

The U-shaped lock-fit edge 340 of the cover 308 may fit around the PCB 350 and, together with the cover 308, protect various electrical components on both surfaces of the PCB 350 from environmental conditions. In particular, the U-shaped edge 340 and the cover 308 may protect the PCB 350 and its electrical components from harmful moisture and other damaging conditions. In some embodiments, the cover 308 and the U-shaped edge 340 are made of silicone. The cover 308 may comprise a suitable number of lenses 332 to accommodate the light sources 354. If the light-distributing properties of the first lighting fixture 300 are to be altered, then it may be possible to replace one or more of the cover 308, light sources 354, or PCB 350 with a different type of the same component.

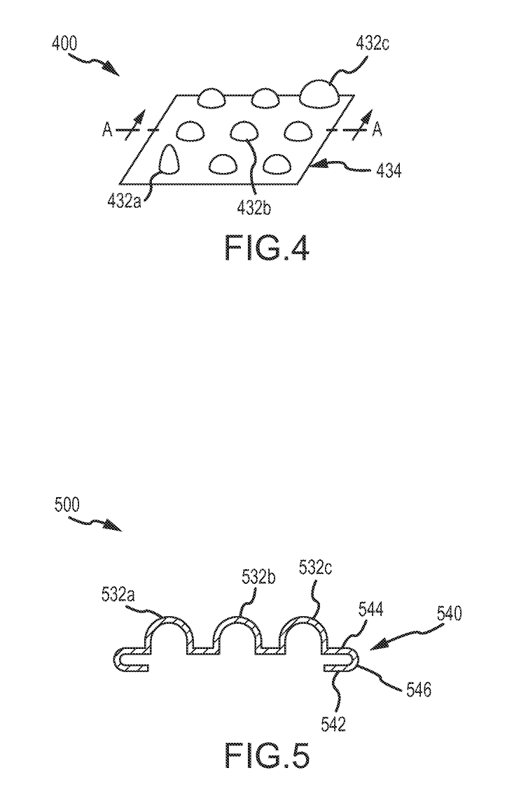

With reference now to FIG. 4, a lighting fixture cover 400 will be described in accordance with at least some embodiments of the present disclosure. The lighting fixture cover may also be referred to herein as lighting canopy cover, lighting cover, and cover. The lighting fixture cover 400 may be used in any of the above-described lighting canopies 100, 200 or lighting fixture 300. The lighting fixture cover 400 may be configured with a number of different lenses 432a-c and a base 434. Specifically, the lighting fixture cover 400 may comprise a first lens 432a of a first lens type, a second lens 432b of a second lens type, and a third lens 432c of a third lens type. The first lens type may be an oval shape, the second lens type may be of one size and circular, and the third lens type may be of another size and circular. Although three lens types are depicted on the lighting fixture cover 400, it should be appreciated that a lighting fixture cover used in accordance with embodiments of the present disclosure may have any different number of lenses 432 and lens types. Specifically, any lighting fixture cover described herein may be provided with one, two, three, four, five, six, seven, eight, or more different types of lenses 432 without departing from the scope of the present disclosure. The different lens types may be different across one or more of size, shape, height, depth, width, reflectivity, material (e.g., epoxy, silicone, a hybrid of silicone and epoxy, phosphor, a hybrid of phosphor and silicone, an amorphous polyamide resin or fluorocarbon, glass, plastic, combinations thereof), diffracting elements, tint/color, inclusions, emission angle, and the like. Accordingly, although the lenses 432a-c are depicted as having different sizes and shapes, it should be appreciated that a lighting fixture cover may be provided with lenses 432 of the same size and shape, but with different reflective angles or emission percentages. For instance, some lenses may be coated with a material to diffuse the light and other lenses may reflect light at other angles.

In some embodiments, each lens 432 is configured to receive a light source. The light sources may be different for different lenses 432. Specifically, some light sources may be brighter or higher intensity than other light sources. In embodiments, some light sources may be different shapes, sizes, or colors than other light sources. Accordingly, the lenses 432 and cover 408 may be designed for a specific light source.

The lighting fixture cover 400, in some embodiments, may be made of silicone to increase the durability and decrease the lighting fixture cover's 400 weight. This may also reduce the overall weight of the lighting fixture. Alternatively, the lighting cover 400 may be manufactured of plastic, glass, polymer, or the like and may be coated with a material to diffuse the light.

FIG. 5 is an A-A view (cross-section) of the lighting fixture cover 400 shown in FIG. 4. In some embodiments, the lighting fixture cover 500 may include, without limitation, one or more lenses 532 and a U-shaped lock-fit edge 540. The U-shaped edge 540 may snap around a PCB, a heat sink, or other surface of a lighting fixture to keep the cover 500 on the lighting fixture. A PCB or heat sink may also pop into the cover 500. The U-shaped edge 540 may go around the entire perimeter of the cover 500 such that the U-shaped edge 540 is on all four sides of the cover 500—if the cover is square-shaped or rectangular—and snaps onto the PCB on all four sides. Alternatively, the U-shaped edge 540 may only be on two or more sides of the cover 500. In a specific embodiment, the cover 500 may be more secure if the U-shaped edge 540 is on every edge of the cover 500. Having the U-shaped edge 540 on every side would further protect the light sources and other electrical components of the lighting fixture from moisture, heat, and weather. In an embodiment, the cover may be round-shaped or oval-shaped depending on the shape of the lighting fixture and PCB to which the cover attaches. Because the cover 500 wraps around the entire top of the lighting fixture, there are less points through which water, heat, and weather can enter the lighting fixture.

In some embodiments, the U-shaped edge 540 has a top surface 544, a side surface 546, and a bottom surface 542. The top surface 544 may lie directly on the top surface of the PCB or other base. Alternatively or additionally, there may be a space between the top surface 544 of the U-shaped edge 540 and the top surface of the PCB. The side surface 546 of the U-shaped edge 540 may directly contact the side surface of the PCB or other base. Further, the U-shaped edge 540 may have a geometry that is the same as or similar to the PCB's side surface geometry such that the U-shaped edge 540 fits snugly with the PCB when attached. In some embodiments, there may be a space between the side surface 546 of the U-shaped edge 540 and the side surface of the PCB. The bottom surface 542 of the U-shaped edge 540 may lie directly below the bottom surface of the PCB or other base. Alternatively, there may be a space between the bottom surface 542 of the U-shaped edge 540 and the bottom surface of the PCB. In a specific embodiment there is as little space between the U-shaped edge 540 and the PCB as possible in order to securely fasten the cover 500 to the PCB. In other embodiments, the U-shaped edge 540 may not be U-shaped and rather may be squared or rounded.

In some embodiments, there are advantages of using a cover 500 with a U-shaped edge 540. First, if the cover 500 is made of a flexible material (e.g., silicone), then the cover 500 may be attached to a PCB or other lighting fixture base by snapping, fastening, clamping, clasping, hooking, pushing, attaching, or securing the U-shaped edge 540 around the PCB or other lighting fixture base. The U-shaped edge 540 may be attached to a PCB or other lighting fixture base by means of a friction fit, snap-fit, interference fit, press fit, mechanical coupling, or the like. The U-shaped edge 540 reduces or eliminates the need to mechanically secure a cover to a PCB or other lighting base using screws. Thus, the U-shaped edge 540 reduces the number of parts (e.g., screws, nuts, bolts, washers, etc.) in the lighting fixture, which also reduces the total weight of the lighting fixture. The reduction in weight may also reduce other risks associated with canopy lighting fixtures. Canopy lighting is often used in high ceilings, especially in warehouses. It can be very dangerous if a canopy lighting fixture falls from the ceiling. Therefore, having a lighter canopy lighting fixture reduces the risk of a lighting fixture falling from the ceiling. Additionally, if the cover 500 is made of a flexible material such as silicone and the lighting fixture falls from the ceiling, less shattering will occur than would with a glass cover.

In an embodiment, it takes less time to snap a flexible cover 500 with a U-shaped edge 540 onto a lighting fixture than it does to mechanically screw a glass cover onto a lighting fixture. Thus, the time and cost to assemble the lighting fixture will be reduced.

Tempered glass covers are breakable and often break during assembly when they are screwed onto the lighting fixture. The breakage of these glass covers imposes additional cost, time, and safety risks in the assembly process. Therefore, if the need for glass covers secured with screws is eliminated, then the cost, time, and safety risks of assembly will be reduced. Manufacturing flexible covers 500 with U-shaped edges 540 according to the embodiments of the present disclosure simplifies the lighting fixture assembly process.

Although three lenses 532a-c are depicted on the lighting fixture cover 500, it should be appreciated that a lighting cover used in accordance with embodiments of the present disclosure may have a greater or lesser number of lenses. Furthermore, the three lenses 532a-c depicted on the lighting fixture cover 500 are the same type, but it should be appreciated that a lighting cover used in accordance with embodiments of the present disclosure may have lenses of two or more different types. The lenses may vary in one or more of size, shape, height, depth, width, reflectivity, material (e.g., epoxy, silicone, a hybrid of silicone and epoxy, phosphor, a hybrid of phosphor and silicone, an amorphous polyamide resin or fluorocarbon, glass, plastic, combinations thereof), diffracting elements, tint/color, inclusions, emission angle, etc.

It should be appreciated that other non-U-shapes can be used for the edge 540 of cover 500. For instance, V-shapes, or any other conformal shape to the outer perimeter of the lighting fixture may be used without departing from the scope of the present disclosure.

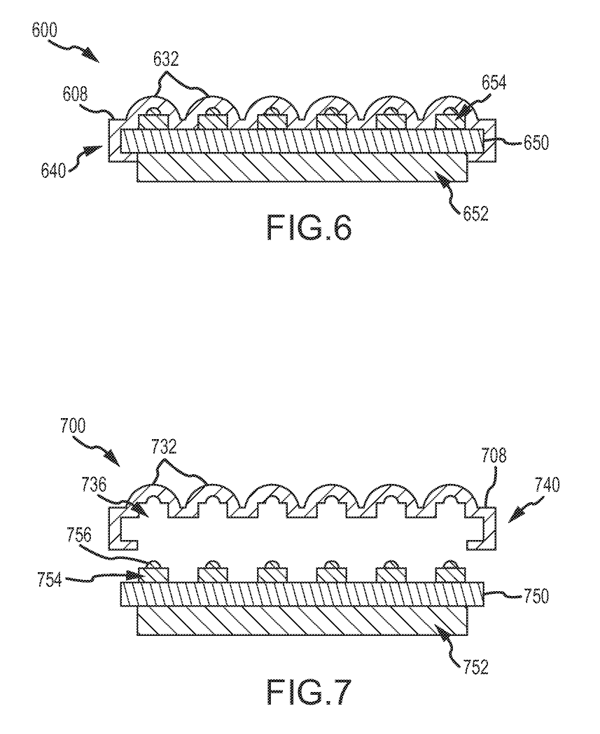

FIG. 6 is a side view of a second lighting fixture 600, which will be described in accordance with embodiments of the present disclosure. The second lighting fixture 600 may include one or more components that enable the second lighting fixture 600 to provide light in a number of different lighting applications (e.g., residential, industrial, commercial, etc.). Furthermore, various components of the second lighting fixture 600 may be interchangeable with other similar types of components described herein. In particular, the components of the second lighting fixture 600 may be modular in nature and are, therefore, easily adaptable to a number of different lighting applications. In some embodiments, the second lighting fixture 600 may be considered a hybrid lighting canopy because it is capable of providing light sources of multiple types (e.g., light sources having different lighting properties). It should be appreciated that the details described herein about the component parts of the second lighting fixture 600 may apply to component parts of the first or second lighting canopy 100, 200 or first lighting fixture 300. Moreover, any aspect described in connection with the first or second lighting canopy 100, 200 or first lighting fixture 300 may apply to the second lighting fixture 600.

Non-limiting example components that may be included in the second lighting fixture 600 include a cover 608 with one or more lenses 632 and a U-shaped edge 640, one or more light sources 654, a PCB 650, and a heat sink 652. In an embodiment, the light sources 654 may be LEDs.

In the embodiment depicted in FIG. 6, the second lighting fixture 600 comprises at least one row of six light sources 654 and six lenses 632. The second lighting fixture 600 may comprise more than one row of light sources 654 and lenses 632. Further, the second lighting fixture 600 may comprise more than six or less than six light sources 654 and lenses 632 in a row. In fact, the second lighting fixture 600 may comprise any number of light sources 654 and lenses 632 such that each row of light sources 654 and lenses 632 may have a different number of light sources 654 and lenses 632 or the light sources 654 and lenses 632 may not be arranged in rows at all.

In some embodiments, some light sources 654 may be brighter or higher intensity than other light sources 654. Further, some light sources 654 may be different shapes/sizes than other light sources 654. Accordingly, the lenses 632 and cover 608 may be designed for a specific light source 654. In some embodiments, each light source 654 may have its own lens 632. In other embodiments, some light sources 654 may have a lens 632 while other light sources 654 may not have a lens 632. In additional embodiments, multiple light sources 654 may share a single lens 632.

In some embodiments, the light sources 654 may each be positioned directly on the PCB 650 or lighting clusters and reflector cups may be used, as was described in the embodiments above. In an embodiment, the cover 608 with lenses 632 may fit directly and snuggly onto the PCB 650 and over the light sources 654. The cover 608 may also have U-shaped edges to form a lock-fit around the PCB 650 and mechanically lock the cover 608 onto the PCB 650 without the use of screws or other hardware.

In some embodiments, the heat sink 652 may be used to transfer heat away from the light sources 654. The heat sink 652 may be composed of any thermally conductive material including, but not limited to, aluminum, aluminum alloys, metal alloys, copper, diamond, synthetic diamond, composite materials, copper-tungsten pseudoalloy, AlSiC (silicon carbide in aluminum matrix), Dymalloy (diamond in copper-silver alloy matrix), and E-Material (beryllium oxide in beryllium matrix). Alternatively or additionally, the heat sink may be metal slugs. In some embodiments, the heat sink 652 may have fins or groves to increase the surface area of the heat sink 652 and, thus, increase the amount of heat that the heat sink 652 can dissipate in a given time. The fins may be cylindrical, elliptical, or square-shaped pins or the fins may be plates that run part of or the entire length of the heat sink 652.

FIG. 7 shows in particular how a cover 708 may be detached from a third lighting fixture 700. It should be appreciated that the details described herein about the component parts of the third lighting fixture 700 may apply to component parts of the first or second lighting canopy 100, 200 or the first or second lighting fixture 300, 600. Moreover, any aspect described in connection with the first or second lighting canopy 100, 200 or the first or second lighting fixture 300, 600 may apply to the third lighting fixture 700.

Non-limiting example components that may be included in the third lighting fixture 700 include a cover 708, one or more light sources 754, a PCB 750, and a heat sink 752. The heat sink 752 may be similar to the heat sink 652 described in accordance with FIG. 6. The cover 708 may include one or more lenses 732, one or more U-shaped edges 740, and one or more pockets 736 for the light sources 754. The pockets 736 may be the same shape as the light sources 754 or may be larger than the light sources 754. Further, the pockets 736 may be designed such that they can accommodate light sources 754 of different shapes, sizes, and types. The pockets 736 may all be the same as one another, as shown in FIG. 7. Alternatively, the pockets 736 may differ in one or more of size, shape, etc. Each pocket 736 may be designed to correspond with a particular light source 754 or lens type. In embodiments, the light sources 754 may be LEDs with an encapsulant 756 on top of the light source 754. The encapsulant 754 may be air, epoxy, or another encapsulating material known in the art.

In the embodiment depicted in FIG. 7, the third lighting fixture 700 comprises at least one row of six light sources 754 and six lenses 732. The third lighting fixture 700 may comprise more than one row of light sources 754 and lenses 732. Further, the third lighting fixture 700 may comprise any number of light sources 754 and lenses 732 arranged in any configuration.

The light sources 754 may each be positioned directly on the PCB 750 or lighting clusters and reflector cups may be used, as was described in the embodiments above. Further, the cover 708 with lenses 732 may fit directly and snuggly onto the PCB 750 and light sources 754. The cover 708 shown on the third lighting fixture 700 may also have U-shaped edges 740 to form a lock-fit around the PCB 750 and mechanically lock the cover 708 onto the PCB 750 without the use of screws or other hardware.

The cover 708 may be attached to the PCB 750 by snapping one U-shaped edge 740 on one side of the PCB 750, then snapping another U-shaped edge 740 on another side and so forth until all U-shaped edges 740 are mechanically attached to the PCB 750.

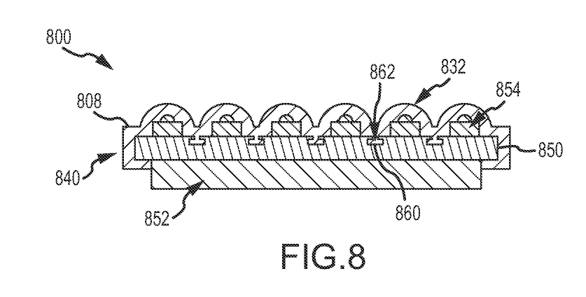

With reference now to FIG. 8, a fourth lighting fixture 800 will be described in accordance with at least some embodiments of the present disclosure. It should be appreciated that the details described herein about the component parts of the fourth lighting fixture 800 may apply to component parts of the first or second lighting canopy 100, 200 or the first, second, or third lighting fixture 300, 600, 700. Moreover, any aspect described in connection with the first or second lighting canopy 100, 200 or the first, second, or third lighting fixture 300, 600, 700 may apply to the fourth lighting fixture 800.

Non-limiting example components that may be included in the fourth lighting fixture 800 include a cover 808, one or more light sources 854 (which may be LEDs in a specific embodiment), a PCB 850 with one or more female mechanical locking mechanisms 860 for securing the cover 808 to the PCB 850, and a heat sink 852. The heat sink 852 may be similar to the heat sink 652 described in accordance with FIG. 6. The cover 808 may include one or more lenses 832, one or more U-shaped edges 840, and one or more male mechanical locking mechanisms 862 for securing the cover 808 to the PCB 850.

In the embodiment depicted in FIG. 8, the fourth lighting fixture 800 comprises at least one row of six light sources 854 and six lenses 832. The fourth lighting fixture 800 may comprise more than one row of light sources 854 and lenses 832. Further, the fourth lighting fixture 800 may comprise any number of light sources 854 and lenses 832 arranged in any configuration.

In an embodiment, the fourth lighting fixture 800 comprises at least one male and female locking mechanism 862, 860 between each lens 832. Some embodiments may include more or less male and female locking mechanisms 862, 860 on the cover 808 and PCB 850. In some embodiments, the male locking mechanism 862 may be one or more of squared-shaped, T-shaped, rounded, latch-shaped, conical, or any other male connector shape known in the art. The female locking mechanism 860 should be shaped such that it corresponds to the shape of the male locking mechanism 862. Accordingly, the female locking mechanism 860 may be one or more of squared-shaped, T-shaped, rounded, latch-shaped, conical, or any other female connector shape known in the art. For example, the male locking mechanism 862 may be a peg and the female locking mechanism 860 may be a hole in which the peg fits. In some embodiments, the male locking mechanism 862 may be a slide or tongue-shaped and the female locking mechanism 860 may be a groove in which the slide or tongue fits. In an embodiment, the male and female locking mechanisms 862, 860 may fit together and prevent the cover 808 from detaching from the PCB 850 without bending, turning, twisting, tugging, or pulling on the cover 808 and/or PCB 850.

The light sources 854 may each be positioned directly on the PCB 850 or lighting clusters and reflector cups may be used, as was described in the embodiments above. Further, the cover 808 with lenses 832 and male locking mechanisms 862 may fit directly and snuggly onto the PCB 850 and light sources 854. The cover 808 shown on the fourth lighting fixture 800 may also include U-shaped edges to form a lock-fit around the PCB 850 and mechanically lock the cover 808 onto the PCB 850 without the use of screws or other hardware. Together, the combination of the male and female locking mechanisms 862, 860 and the U-shaped edges 840 may securely fasten the cover 808 onto the fourth lighting fixture 800.

Regarding FIGS. 6-8, in some embodiments, the cover 608, 708, 808 with lenses 632, 732, 832 may be used to emit light beams at a desired angle. More specifically, the lenses 632, 732, 832 may emit light at narrow viewing angles, e.g., less than 40 degrees. Further, the lenses 632, 732, 832 may achieve an oval shape with a viewing angle of less than 40 degrees.

In some embodiments, the light sources 654, 754, 854 may correspond to LEDs. Any type of known LED may be mounted to the PCB 650, 750, 850 including, without limitation, Surface Mount Technology (SMT) LED, through mount LEDs, or combinations thereof. The pattern in which the light sources 654, 754, 854 are mounted on the PCB 650, 750, 850 may correspond to the same pattern of lenses 632, 732, 832 on a cover 608, 708, 808. The light sources 654, 754, 854 may be interchangeable and modular, which means that a light source 654, 754, 854 of one type may be replaced with a light source 654, 754, 854 of another type by simply removing the cover 608, 708, 808, removing the light source 654, 754, 854, then mounting a different light source 654, 754, 854 to the PCB 650, 750, 850.

In some embodiments, the PCB 650, 750, 850 is a conventional PCB 650, 750, 850 that comprises composites manufactured in accordance with the FR-4 and/or G-10 specification. It should be appreciated, however, that the PCBs 650, 750, 850 may be rigid or flexible without departing from the scope of the present disclosure.

The U-shaped lock-fit edge 640, 740, 840 of the cover 608, 708, 808 may fit around the PCB 650, 750, 850 and-together with the cover 608, 708, 808-protect various electrical components on both surfaces of the PCB 650, 750, 850 from environmental conditions. In particular, the U-shaped edge 640, 740, 840, and the cover 608, 708, 808 may protect the PCB 650, 750, 850 and its electrical components from harmful moisture and other damaging conditions. In some embodiments, the cover 608, 708, 808 and the U-shaped edge 640, 740, 840 may be made of silicone. The cover 608, 708, 808 may comprise a suitable number of lenses 632, 732, 832 to accommodate the light sources 654, 754, 854. If the light-distributing properties of the lighting fixture 600, 700, 800 are to be altered, then it may be possible to replace one or more of the cover 608, 708, 808; light sources 654, 754, 854; or PCB 650, 750, 850 with a different type of the same component.

In some embodiments, the various lenses 632, 732, 832 on the cover 608, 708, 808 may be different lens types and may be different across one or more of shape (e.g., domed, flat, multi-focal, etc.), material (e.g., epoxy, silicone, a hybrid of silicone and epoxy, phosphor, a hybrid of phosphor and silicone, an amorphous polyamide resin or fluorocarbon, glass, plastic, combinations thereof), diffracting elements, tint/color, inclusions, dye, color, emission angle, height, width, depth, reflectivity, and the like. Accordingly, although the lenses 632, 732, 832 are depicted as having the same sizes and shapes, it should be appreciated that a lighting fixture cover 608, 708, 808 may be provided with lenses 632, 732, 832 of the same sizes and shapes, but with different light emission angles, or the lenses 632, 732, 832 may be of different shapes and sizes. Furthermore, some lenses 632, 732, 832 may be coated with a material to diffuse the light.

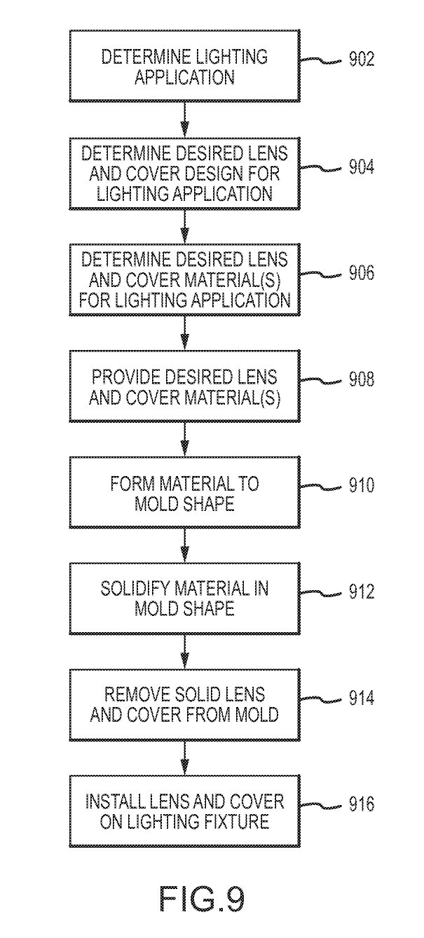

With reference now to FIG. 9, a lighting cover manufacturing method will be described in accordance with embodiments of the present disclosure. The method is initiated by determining a lighting application or area to light (step 902). As noted above, the lighting application may vary from location to location and each location may require different lighting needs. The lighting needs may depend upon ambient lighting conditions, light requirements, and the like.

Based on the lighting application, an optimal lens and cover configuration is determined (step 904). The optimal lens and cover design may require lenses of a single type. However, many lighting applications may benefit from the use of a hybrid lighting canopy that comprises light sources and lenses of different types.

Based on the lighting application and lens and cover design, an optimal lens and cover material(s) is determined (step 906). The optimal lens and cover material(s) may require a single material or a combination of two or more materials. Once the material(s) is chosen, the material(s) is provided (step 908).

One or more cover molds are then provided with the determined optimal design and the desired material(s) is formed to the mold shape (step 910). Specifically, the cover mold may be provided with a number of different lenses that may or may not be of different types, shapes, and sizes. In some embodiments, the mold may be in the shape of one of the covers 108, 208, 308, 400, 500, 608, 708, 808 or a cover having one or more lenses with different light-directing features.

Once the material(s) is in the mold, the material(s) must solidify in the shape of the mold (step 912). Thus, the material(s) is now in the shape of the optimal lens and cover design. After the material(s) has solidified into the shape of the desired lens and cover design, the lighting fixture cover is removed from the mold (step 914).

The optimal lighting fixture cover is then installed on the lighting fixture (step 916). The cover may be installed by snapping the cover on to a lighting fixture, which may be one of the first or second lighting canopy 100, 200 or the first, second, third, or fourth lighting fixture 300, 600, 700, 800.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A lighting system, comprising:
a Printed Circuit Board (PCB) having a plurality of light sources connected thereto;
a heat sink thermally coupled to the PCB; and
a cover having one or more lenses and one or more snap-fit mechanisms configured to interface the cover with at least one of the PCB and heat sink, wherein a first lens in the one or more lenses is positioned above a first light source in the plurality of light sources.

2. The system of claim 1, wherein a top surface of the PCB comprises one or more indentions, wherein a bottom surface of the cover comprises one or more protrusions, and wherein the one or more protrusions mechanically interface with the one or more indentions.

3. The system of claim 1, wherein a second lens in the one or more lenses is positioned above a second light source in the plurality of light sources.

4. The system of claim 3, wherein the first lens comprises at least one light-directing property that is different from the second lens.

5. The system of claim 3, wherein the first light source is different from the second light source in at least one of brightness, intensity, shape, size, and color.

6. The system of claim 1, wherein the one or more lenses produce a narrow-angle beam of light.

7. The system of claim 1, wherein the cover is modular and removable from the PCB.

8. A lighting fixture, comprising:
a first light source;
a second light source;
a base; and
a cover, wherein the cover comprises:
a first lens;
a second lens; and
one or more edges configured to interface with an outer perimeter of the base, wherein the first lens is positioned over the first light source and the second lens is positioned over the second light source.

9. The lighting fixture of claim 8, wherein the base is a printed circuit board.

10. The lighting fixture of claim 8, wherein the first lens comprises at least one light-shaping property that is different from the second lens.

11. The lighting fixture of claim 8, wherein at least one lens produces a narrow-angle beam of light.

12. The lighting fixture of claim 8, wherein the cover is modular and removable from the base.

13. The lighting fixture of claim 8, further comprising a third light source, wherein the first lens is positioned over the first light source and the third light source.

14. A modular cover for use in a lighting fixture, the cover comprising:
a first lens;
a second lens; and
a snap-fit edge, wherein the cover and the first and second lenses are established in a single piece of material, wherein the cover is formed of a flexible material.

15. The cover of claim 14, wherein the cover is shaped to fit on a lighting canopy.

16. The cover of claim 14, wherein at least one lens produces a narrow-angle beam of light.

17. The cover of claim 14, wherein the first lens comprises at least one of a different shape, size, color, tint, diffracting element, inclusion, height, and depth than the second lens.

18. The cover of claim 14, wherein the flexible material is silicone.

19. The cover of claim 14, wherein the first lens is of a first type and comprising a first set of light-directing properties, wherein the second lens is of a second type and comprising a second set of light-directing properties, and wherein the first set of light-directing properties is different than the second set of light-directing properties.

20. The cover of claim 14, wherein a bottom side of the cover comprises one or more protrusions configured to interface the cover with at least one of a printed circuit board, a base, and a surface of the lighting fixture.
